(19) United States
(12) Patent Application Publication
(10) Pub. No.: US 2026/0180252 A1
(43) Pub. Date: Jun. 25, 2026

(54) DOUBLE-LAYER CIRCUIT BOARD CONNECTOR STRUCTURE AND ASSEMBLY METHOD THEREOF

(71) Applicant: JPC CONNECTIVITY INC., New Taipei City (TW)

(72) Inventor: Chieh-Ming CHENG, New Taipei City (TW)

(21) Appl. No.: 19/060,707

(22) Filed: Feb. 23, 2025

(30) Foreign Application Priority Data
Dec. 19, 2024 (TW) 113149661

(51) Int. Cl. H01R 13/6461; H01R 12/62; H01R 12/72; H01R 13/512; H01R 13/6587

(52) U.S. Cl. CPC H01R 13/6461; H01R 12/62; H01R 12/721; H01R 13/512; H01R 13/6587

(57) ABSTRACT

A double-layer circuit board connector structure having a housing and an assembly method thereof are disclosed. The double-layer circuit board connector structure includes a housing having an accommodating space; a first circuit module arranged inside the accommodating space and having a first circuit board, a first molding block and first connecting members electrically connected to a rear end of the first circuit board; a second circuit module arranged inside the accommodating space and stacked on the first circuit module and having a second circuit board, a second molding block and second connecting members electrically connected to a rear end of the second circuit board; and a shielding member arranged between the first circuit board and the second circuit board and having a first shielding surface and a second shielding surface facing toward electrical connection areas of the first connecting members and second connecting members respectively.

### BACKGROUND OF THE DISCLOSURE

### Technical Field

The present disclosure relates to a connector, and in particular, to a double-layer circuit board connector structure and an assembly method thereof, capable of achieving a shielding effect.

### Description of Related Art

With the rapid technology development, the design of current connectors mainly focuses on the trend of high density and compact size. Accordingly, the design of double-layer circuit boards becomes popular nowadays. However, for a double-layer circuit board connector structure, the main drawback is the crosstalk between the two circuit boards. Accordingly, it is important to overcome such drawback related to the crosstalk generated between the two circuit boards of a double-layer circuit board.

In view of the above, the inventor seeks to improve and overcome the aforementioned drawbacks and proposes a reasonable design capable of effectively improving the aforementioned drawbacks after extensive research along with the utilization of academic principles.

### SUMMARY OF THE INVENTION

An objective of the present disclosure is to provide a double-layer circuit board connector structure and an assembly method thereof, capable of reducing the crosstalk generated between the two layers of circuit boards.

To achieve the aforementioned objective, the present disclosure provides a double-layer circuit board connector structure having a housing, a first circuit module, a second circuit module and a shielding member. The housing includes an accommodating space formed therein, and the accommodating space extends toward a front of the housing and includes an insertion opening. The first circuit module, arranged inside the accommodating space, includes a first circuit board, a first molding block and a plurality of first connecting members. A front end of the first circuit board faces toward the insertion opening, and each of the first connecting members is electrically connected to a rear end of the first circuit board. The first molding block is attached to the rear end of the first circuit board, allowing the first connecting members to pass through an internal of the first molding block and to protrude outward from a rear end thereof. The second circuit module, arranged inside the accommodating space and stacked on the first circuit module, includes a second circuit board, a second molding block and a plurality of second connecting members. A front end of the second circuit board faces toward the insertion opening, and each of the second connecting members is electrically connected to a rear end of the second circuit board. The second molding block is attached to the rear end of the second circuit board, allowing the second connecting members to pass through an internal of the second molding block and to protrude outward from a rear end thereof. The shielding member, arranged between the first circuit board and the second circuit board, includes a first shielding surface facing toward an electrical connection area between the first connecting members and the first circuit board, and a second shielding surface facing toward an electrical connection area between the second connecting members and the second circuit board.

To achieve the aforementioned objective, the present disclosure provides an assembly method for a double-layer circuit board connector, used for assembling the double-layer circuit board connector structure; wherein the insertion opening of the housing includes an insertion direction, and the first circuit module, the second circuit module and the shielding member are stacked onto each other along an assembly direction and are installed inside the accommodating space of the housing, and the assembly direction is perpendicular to the insertion direction.

### BRIEF DESCRIPTION OF THE DRAWINGS

FIG. 1 is a perspective assembly view of the present disclosure;

FIG. 2 is a perspective exploded view of the present disclosure;

FIG. 3 is a perspective exploded view of the first circuit module, the second circuit module and the shielding member of the present disclosure;

FIG. 4 is a perspective partial exploded view of the first circuit module of the present disclosure;

FIG. 5 is a perspective partial exploded view of the second circuit module of the present disclosure;

FIG. 6 is a partial cross-sectional view of the present disclosure;

FIG. 7 is another partial cross sectional view of the present disclosure; and

FIG. 8 is a cross-sectional view of FIG. 7 taken along line 8-8.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

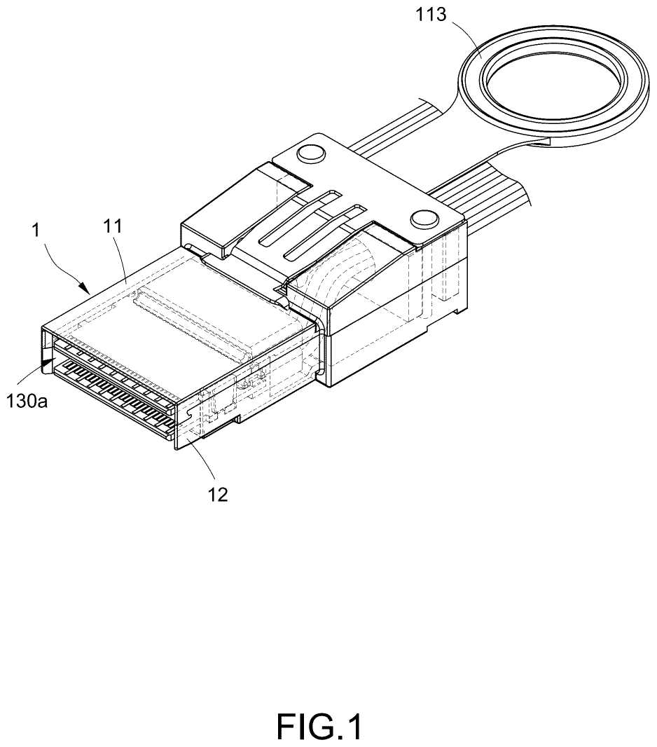

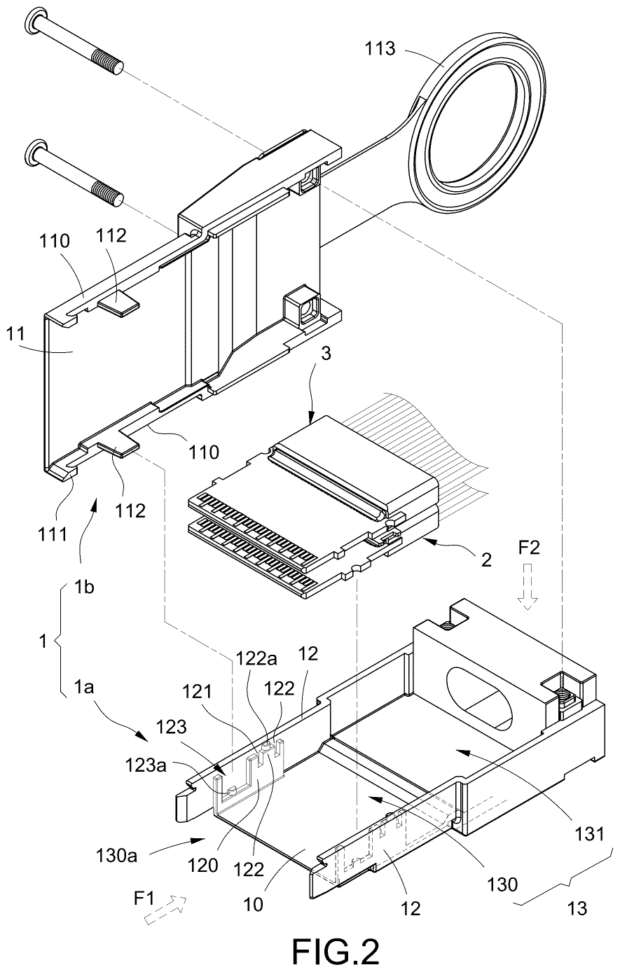

Please refer to FIG. 1 to FIG. 2, showing a perspective assembly view and a perspective exploded view of the present disclosure respectively. The present disclosure provides a double-layer circuit board connector structure and an assembly method thereof. The connector structure includes a housing 1, a first circuit module 2, a second circuit module 3 and a shielding member 4.

The housing 1 is used to cover the members described above and includes a first housing plate 10, a second housing plate 11 and two side housing plates 12. The first housing plate 10 and the second housing plate 11 are arranged spaced apart and opposite from each other vertically, and the two side housing plates 12 are connected between the first housing plate 10 and the second housing plate 11 respectively to form an enclosure of an accommodating space 13 inside the housing 1. The accommodating space 13 is provided to accommodate the first circuit module 2 and the second circuit module 3 therein. In addition, the accommodating space 13 includes a front end area 130 and a rear end area 131. The front end area 130 further includes an insertion opening 130a formed to extend toward the front of the housing 1. In an exemplary embodiment of the present disclosure, the housing 1 includes a first housing member 1a and a second housing member 1b. The first housing member 1a includes the first housing plate 10 and two side housing plates 12. The second housing member 1b includes the second housing plate 11. In addition, two sides of the second housing plate 11 respectively include a side edge 110 bent downward, and the two side edges 110 are correspondingly attached to the two side housing plates 12 respectively. Furthermore, the front end of each of the side edges 110 further includes a locking portion 111 for locking onto the front end of each of the side housing plates 12 for attachment in position. Moreover, fasteners, such as bolts, may be used to assemble and to secure the first housing member 1a and the second housing member 1b together to form an assembly.

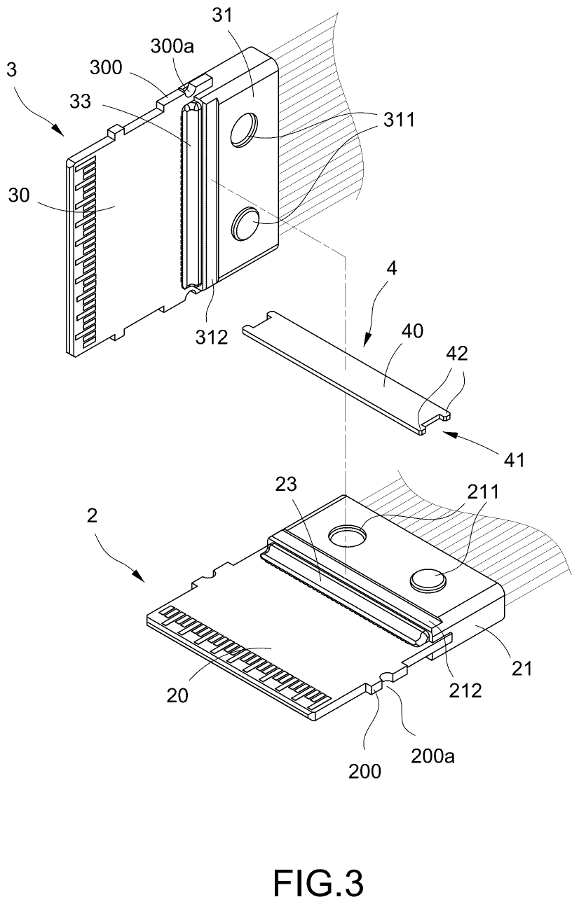

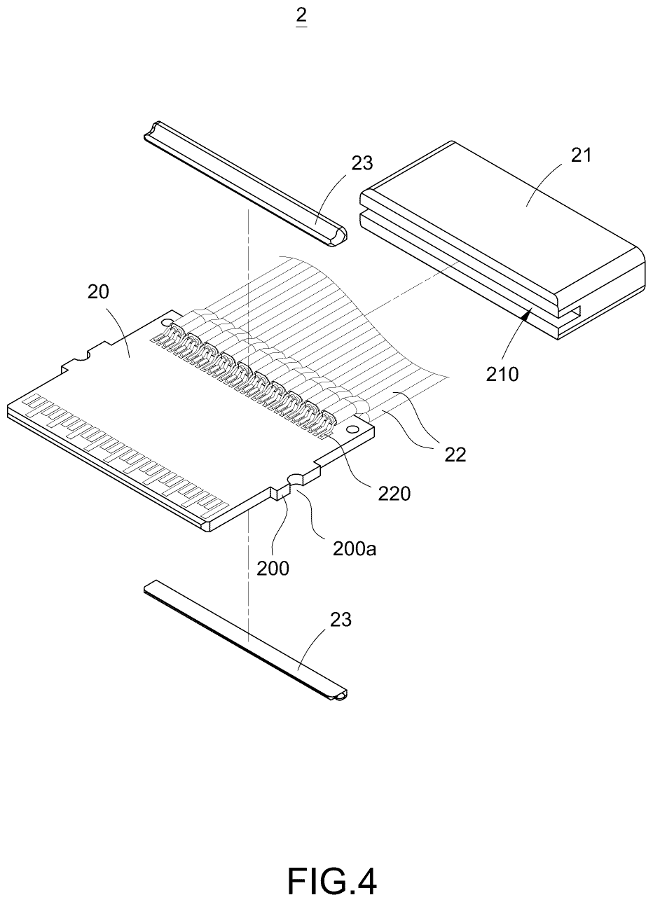

As shown in FIG. 2 and FIG. 3, the first circuit module 2 and the second circuit module 3 are stacked together for arranging inside the accommodating space 13. In addition, the shielding member 4 is held between the first circuit module 2 and the second circuit module 3. The shielding member 4 may be made of an electrically conductive material, such as metal or graphite material. As shown in FIG. 4, the first circuit module 2 includes a first circuit board 20, a first molding block 21 and a plurality of first connecting members 22. Each of the first connecting members 22 may be a wire or a terminal, and its front end 220 may be soldered to the rear end of the first circuit board 20 to establish an electrical connection. Furthermore, the first molding block 21 is attached to the rear end of the first circuit board 20 via the plastic covering and injection molding method, such that the first connecting members 22 are able to pass through the internal of the first molding block 21 and to extend outward from the rear end of the first molding block 21. To be more specific, the first molding block 21 covers and is formed on the first circuit board 20 and also includes a first insertion slot 210 attached to the rear end of the first circuit board 20, allowing the attachment or soldering portion of the front end 220 of each of the first connecting members 22 and the first circuit board 20 to be exposed. Moreover, the attachment or soldering portion is further coated with a first insulation layer 23 made of a material, such as UV gel, for sealing and protection. When the first connecting members 22 are wires, the front ends 220 of the first connecting members 22 are exposed wire cores. In addition, the exposed wire cores of the first connecting members 22 are covered by the first insulation layer 23, and the rest of other portions are covered by the first molding block 21.

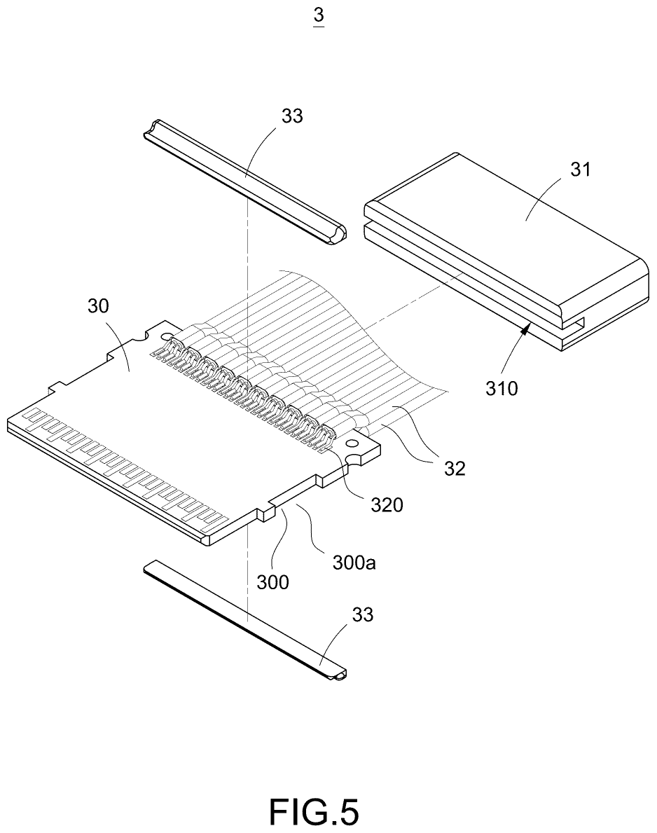

As shown in FIG. 5, the second circuit module 3 includes a second circuit board 30, a second molding block 31 and a plurality of second connecting members 32. Each of the second connecting members 32 may be a wire or a terminal, and its front end 320 may be soldered to the rear end of the second circuit board 30 to establish electrical connection. Furthermore, the second molding block 31 is attached to the rear end of the second circuit board 30 via the plastic covering and injection molding method, such that the second connecting members 32 are able to pass through the internal of the second molding block 31 and to extend outward from the rear end of the second molding block 31. To be more specific, the second molding block 31 covers and is formed on the second circuit board 30 and also includes a second insertion slot 310 attached to the rear end of the second circuit board 30, allowing the attachment or soldering portion of the front end 320 of each of the second connecting members 32 and the second circuit board 30 to be exposed. Moreover, the attachment or soldering portion is further coated with a second insulation layer 33 made of a material, such as UV gel, for sealing and protection. When the second connecting members 32 are wires, the front ends 320 of the second connecting members 32 are exposed wire cores. In addition, the exposed wire cores of the second connecting members 32 are covered by the second insulation layer 33, and the rest of other portions are covered by the second molding block 31.

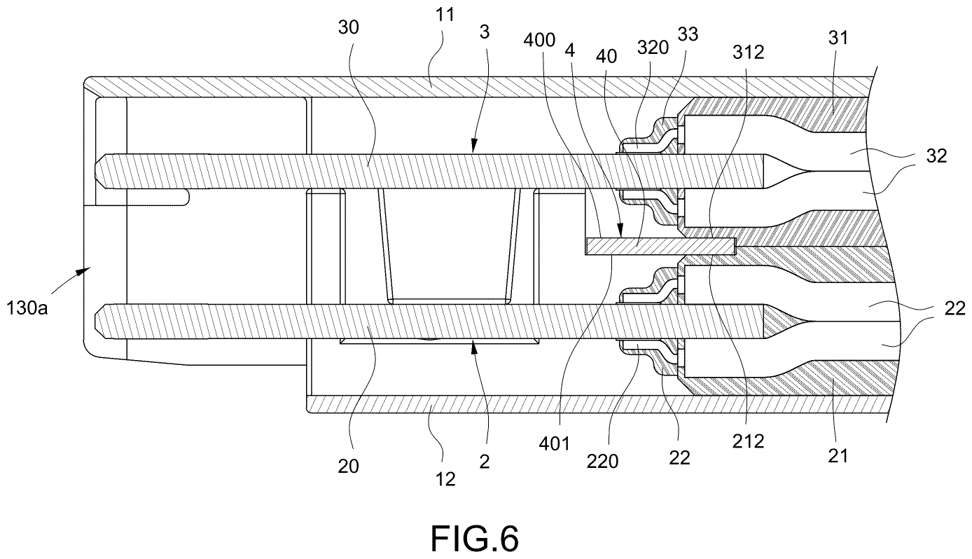

Please refer to FIG. 2, FIG. 3 and FIG. 6. In an exemplary embodiment of the present disclosure, the first circuit module 2, the second circuit module 3 and the shielding member 4 are arranged inside the accommodating space 13 of the housing 1. To be more specific, the first molding block 21 of the first circuit module 2 includes one or a plurality of first locking portions 211, and the second molding block 31 of the second circuit module 3 correspondingly includes one or a plurality of second locking portions 311. The second molding block 31 is aligned with and secured to the first locking portions 211 of the first molding block 21 with the second locking portions 311 to hold the shielding member 4 between the first circuit board 20 and the second circuit board 30. The first circuit board 20 and the first molding block 21 of the first circuit module 2, and the second circuit board 30 and the second molding block 31 of the second circuit module 3 are located at the front end area 130 of the accommodating space 13. The first connecting members 22 of the first circuit module 2 and the second connecting members 32 of the second circuit module 3 are located at the rear end area 131 of the accommodating space 13 and extend outward therefrom. Furthermore, the front ends of the first circuit board 20 and the second circuit board 30 face toward the insertion opening 130a to allow a connector (not shown in the drawings) to be inserted therein along an insertion direction F1. As shown in FIG. 3 and FIG. 6, the shielding member 4 may be held vertically by the first molding block 21 and the second molding block 31. The first molding block 21 includes a first groove 212, and the second molding block 31 includes a second groove 312. When the first molding block 21 is secured to the second molding block 31, the first groove 212 and the second groove 312 are arranged corresponding to each other vertically to hold the rear edge of the shielding member 4. In addition, the shielding member 4 includes a first shielding surface 401 and a second shielding surface 400 extended forward therefrom. The first shielding surface 401 faces toward the electrical connection area between the first connecting members 22 and the rear end of the first circuit board. The second shielding surface 400 faces toward the electrical connection area between the second connecting members 22 and the rear end of the second circuit board 30. Accordingly, the shielding member 4 is able to shield the soldering areas of the first circuit module 2 and the second circuit module 3 respectively to reduce the crosstalk between the first circuit board 20 and the second circuit board 30.

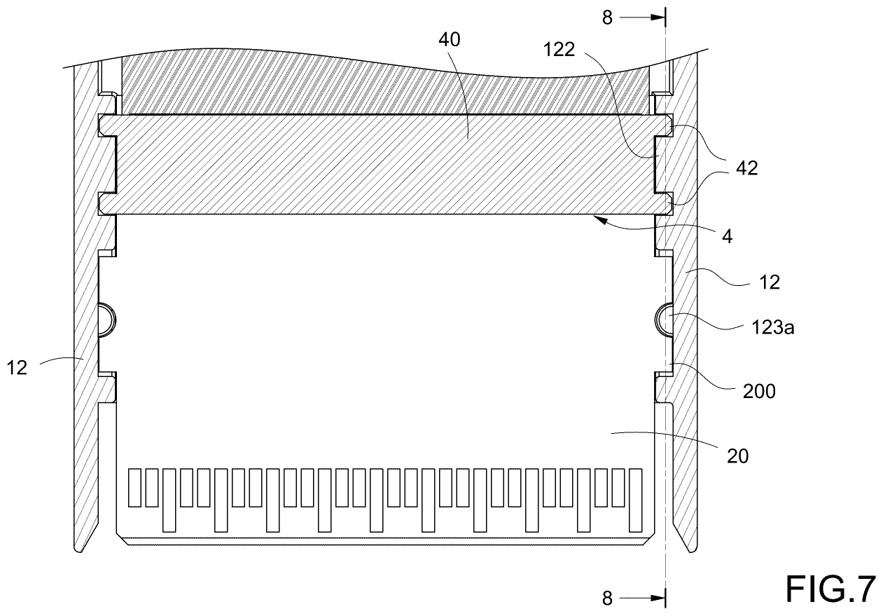

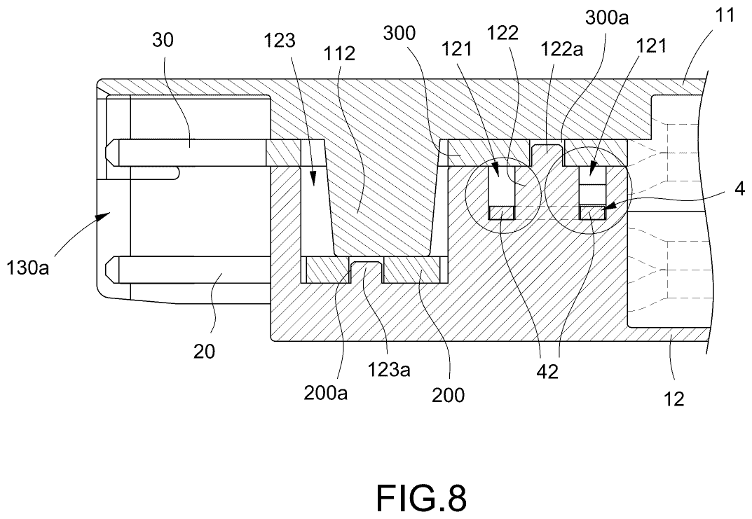

As shown in FIG. 2 and FIG. 7, in an exemplary embodiment of the present disclosure, the first circuit module 2, the second circuit module 3 and the shielding member 4 are stacked onto each other vertically along an assembly direction F2 for installation inside the housing 1. In addition, the assembly direction F2 is perpendicular to the insertion direction F1 of the insertion opening 130a. Accordingly, it is able to withstand a greater insertion and pulling force exerted thereon to achieve a stronger assembly structure. As shown in FIG. 3, two sides of the first circuit board 20 respectively include a first latching portion 200, and the first latching portion 200 includes a first locking slot 200a formed thereon. In addition, two sides of the second circuit board 30 also respectively include a second latching portion 300, and the second latching portion 300 includes a second locking slot 300a. The shielding member 4 includes a shielding main body 40 having a plate shape. Furthermore, two sides of the shielding main body 40 respectively include a notch 41, and each of the notches include two protrusions 42 protruded therefrom respectively. Please refer to FIG. 2 and FIG. 8. The inner walls of the two side housing plates 12 of the housing 1 include a protruding wall 120 formed thereon respectively. Each of the protruding walls 120 include at least one slide-in slot 121 and a slide-in block 122 respectively. The slide-in block 122 includes a second locking point 122a, and the protruding wall includes a positioning slot 123 formed adjacent to the insertion opening 130a. In addition, the positioning slot 123 includes a first locking point 123a.

Accordingly, as shown in FIG. 2 and FIG. 6 to FIG. 8, when the first circuit module 2 is placed inside the accommodating space 13 via the first circuit board 20, the first latching portion 200 of the first circuit board 20 is able to engage with the positioning slot 123 along the vertical assembly direction F2 to be installed inside the housing 1 and to be arranged adjacent to and opposite from the first housing 10. In addition, the first locking slot 200a is also locked onto the first locking point 123a. Next, the shielding member 40 is stacked on the first molding block 21 along the assembly direction F2 as the notch 41 and the protrusion 42 engaging with slide-in block 122 and the slide-in slot 121 respectively. Finally, the second latching portion 300 of the second circuit board 30 is arranged to correspond to the slide-in block 122 along the assembly direction F2 to allow the second locking slot 300a to be locked onto the second locking point 122a, such that the second molding block 31 is stacked on the shielding main body 40, and the second circuit board 30 is also arranged adjacent to and opposite from the second housing plate 11. As a result, the first circuit module 2, the second circuit module 3 and the shielding member 4 are assembled inside the housing 1 via the vertical stacking method, and the first housing member 1a and the second housing member 1b of the housing 1 are assembled together. The two side edges 110 of the second housing plate 11 respectively include a positioning slab 112, and the positioning slab 112 extend toward the positioning slot 123 to abut against the first latching portion 200. The second latching portion 300 abuts against the two side edges of the second housing plate 11. Through the assembly along the vertical assembly direction F2, the connector is able to withstand a greater force exerted in the pulling or insertion direction F1 during the pulling and insertion process without damage. Furthermore, the rear side of the second housing plate 11 further includes a pull handle 113 to facilitate the pulling of the connector during the insertion and pulling process.

Moreover, during the assembly of the present disclosure, the first circuit module 2, the second circuit module 3 and the shielding member 4 may be stacked onto each other vertically first to be further installed inside the first housing member 1a or the second housing member 1b of the housing 1, following which the first housing member 1a and the second housing member 1b are then assembled together. Alternatively, in another exemplary embodiment, the first circuit module 2, the shielding member 4 and the second circuit module 3 may also be sequentially assembled inside the first housing member 1a, following which the first housing member 1a and the second housing member 1b may be further assembled together.

With the aforementioned structure and configuration, the double-layer circuit board connector structure and the assembly method thereof of the present disclosure are achieved.

The above description is provided to illustrate the exemplary embodiments of the present disclosure only such that it shall not be treated as limitation to the claimed scope of the present disclosure. In addition, any equivalent modification made based on the present disclosure shall be considered to be within the claimed scope of the present disclosure.

What is claimed is:

1. A connector structure, comprising:
a housing, comprising an accommodating space and an insertion opening defined on the front side thereof communicating with accommodating space;
a first circuit module, arranged inside the accommodating space, comprising a first circuit board, a first molding block and a plurality of first connecting members, a front end of the first circuit board facing the insertion opening, and each of the first connecting members electrically connected to a rear end of the first circuit board, and the first molding block attached to the rear end of the first circuit board to make the first connecting members pass through the first molding block to protrude outward from a rear end of the first molding block;
a second circuit module, arranged inside the accommodating space and stacked on the first circuit module, comprising a second circuit board, a second molding block and a plurality of second connecting members, a front end of the second circuit board facing the insertion opening, and each of the second connecting members electrically connected to a rear end of the second circuit board, and the second molding block attached to the rear end of the second circuit board to make the second connecting members pass through the second molding block to protrude outward from a rear end of the second molding block; and
a shielding member, arranged between the first circuit board and the second circuit board, comprising a first shielding surface facing an electrical connection area between the first connecting members and the first circuit board, and a second shielding surface facing an electrical connection area between the second connecting members and the second circuit board.

2. The connector structure according to claim 1, wherein the housing further comprises a first housing plate, a second housing plate and two side housing plates, the first housing plate and the second housing plate are arranged spacedly in a vertical direction, and the two side housing plates are connected between the first housing plate and the second housing plate respectively.

3. The connector structure according to claim 2, wherein the housing comprises a first housing member and a second housing member, the first housing member is structured by the first housing plate and the two side housing plates, the second housing member is structured by the second housing plate, the second housing plate comprise two side edges bent downward from two sides thereof, and the two side edges are correspondingly attached to the two side housing plates respectively.

4. The connector structure according to claim 2, wherein the second housing plate comprises two side edges bent downward from two sides thereof, and the two side edges are correspondingly attached to the two side housing plates respectively.

5. The double-layer circuit board connector structure according to claim 2, wherein the housing comprises a protruding wall disposed on an inner wall of each side housing plate, the protruding wall comprises at least one slide-in slot and a slide-in block, the shielding member comprises a notch defined concavely on a side thereof and at least one protrusion disposed protrusively on the side thereof, the shielding member is assembled inside the accommodating space via the notch and the protrusion engaging with the slide-in block and the slide-in slot respectively.

6. The connector structure according to claim 5, wherein the protruding wall further comprises a positioning slot defined concavely adjacent to the insertion opening, the first circuit board comprises two first latching portions disposed on two sides thereof, the first circuit module is assembled inside the housing and arranged adjacent to the first housing plate via the first latching portion engaging with the positioning slot.

7. The connector structure according to claim 6, wherein the second housing plate comprises two positioning slabs disposed on two sides thereof, and the positioning slabs extend toward the positioning slot to abut against the first latching portions.

8. The connector structure according to claim 5, wherein the second circuit board comprises two second latching portions disposed on two sides thereof, the second circuit board is assembled inside the housing and arranged adjacent to the second housing plate via the second latching portion arranged corresponding to the slide-in block.

9. The connector structure according to claim 1, wherein the first molding block covering the first circuit board and comprises a first insertion slot embedded to the rear end of the first circuit board to expose an attachment portion of a front end of each of the first connecting members and the first circuit board; the second molding block covering the second circuit board and comprises a second insertion slot embedded to the rear end of the second circuit board to expose an attachment portion of a front end of each of the second connecting members and the second circuit board.

10. The connector structure according to claim 9, wherein a first insulation layer and a second insulation layer are respectively disposed on the attachment portion of each of the first connecting members and the first circuit board, and the attachment portion of each of the second connecting members and the second circuit board.

11. The connector structure according to claim 1, wherein the first molding block comprises one or a plurality of first locking portions, the second molding block correspondingly comprises one or a plurality of second locking portions, and the second molding block is aligned with and secured to the first locking portions via the second locking portions to hold the shielding member.

12. The connector structure according to claim 1, wherein the first molding block comprises a first groove, the second molding block comprises a second groove, and the first groove and the second groove are arranged opposite from each other vertically to hold a rear edge of the shielding member.

13. An assembly method, used for assembling the connector structure according to claim 1; wherein the insertion opening of the housing comprises an insertion direction, and the first circuit module, the second circuit module and the shielding member are stacked onto each other along an assembly direction and are installed inside the accommodating space of the housing, and the assembly direction is perpendicular to the insertion direction.

14. The assembly method according to claim 13, wherein the housing comprises a first housing member and a second housing member, and the first circuit module, the second circuit module and the shielding member are stacked onto each other vertically to be further installed inside the first housing member or the second housing member, and then the first housing member and the second housing member are assembled together.

15. The assembly method according to claim 13, wherein the housing comprises a first housing member and a second housing member, and the first circuit module, the shielding member and the second circuit module are sequentially assembled inside the first housing member, and then the first housing member and the second housing member are further assembled together.
